(19) United States
(12) Patent Application Publication
(10) Pub. No.: US 2011/0116265 A1
(43) Pub. Date: May 19, 2011

(54) Illumination Apparatus

(76) Inventor: Markus Salm, Heusweiler (DE)

(21) Appl. No.: 12/992,515

(22) PCT Filed: May 13, 2009
(86) PCT No.: PCT/EP2009/003415

§ 371 Date: Feb. 2, 2011

Related U.S. Application Data
(60) Provisional application No. 61/052,923, filed on May 13, 2008.

(51) Int. Cl. F21V 7/00

(52) U.S. Cl. 362/247

(57) ABSTRACT

Embodiments show an illumination apparatus having a first light source configured to emit a first light beam, having a first footprint and a second light source configured to emit a second light beam, having a second footprint. The first light source and the second light source are arranged facing each other. The illumination apparatus further having an optical element with two reflecting surfaces. The optical element is arranged between the first light source and the second light source, wherein the two reflecting surfaces are arranged relative to each other so that the first light beam is reflected at the first reflecting surface and the second light beam is reflected at the second reflecting surface, so that the first reflected light beam and the second reflected light beam are aligned next to each other forming a combined light beam with a combined footprint having a first footprint and a second footprint aligned next to each other.

### CROSS-REFERENCE TO RELATED APPLICATION

This application is a U.S. National Phase entry of PCT/EP2009/003415 filed May 13, 2009, and claims priority to U.S. Patent Application No. 61/052,923 filed May 13, 2008, each of which is incorporated herein by references hereto.

### BACKGROUND OF THE INVENTION

The present invention relates to an illumination apparatus, particularly to an illumination apparatus forming a certain light emitting diode (LED) spot. For some lighting systems it may be useful to combine the separate light beams of several light sources in such a way, that a common useful light beam is formed from the plurality of single light beams. Such a combined light beam may comprise an enlarged combined spot or footprint and a multiple of light energy. This means the dimensions of the combined footprint may be enlarged compared to the dimensions of a spot or a single light source.

So far, there exist a couple of illumination systems or projectors which are configured to combine the light beams of different light sources in one light beam, in order to increase the light intensity of this combined light beam. For example, the U.S. Pat. No. 6,341,876 B1 describes an illumination system for illuminating a spatial light modulator. The illumination system comprises two separate light sources wherein the light output of the light sources is combined by means of an integrator rod. This integrator rod is configured to produce a uniform beam for illuminating a spatial light modulator. The integrator rod is effective to combine light from the two separate light sources in order to provide a sufficiently intense light beam to address such a digital micro mirror device. This means the integrator rod overlaps the light beams of the separated light sources in order to increase the light intensity of the combined beam.

The U.S. Pat. No. 5,504,544 discloses a projection system which efficiently combines the output of multiple lamps, images of which are focused to a common point. As a consequence, the projected screen brightness is multiplied over that of a conventional single lamp of equivalent power. superposition is accomplished by a series of Fresnel collecting and focusing lenses, and a linear beam combining prismatic film that utilizes total internal reflection. The projection system is used to overlap the light beams of the multiple lamps.

An optical illumination apparatus including among others a plurality of light sources, a reflecting apparatus for reflecting light in a predetermined direction and a converging apparatus for accepting the light from the reflecting apparatus and sending out substantially parallel light is shown in the U.S. Pat. No. 6,224,217 B1. According to the description, focused light beams of two light sources are reflected at a prism and after the reflection the light from the light sources is converged near an optical axis of the optical illumination apparatus and is synthesized. This means the light from the light sources is mixed and the light beams are overlapping. A converging means, for example, condenser lens is used to form the synthesized combined light beam into a nearly parallel light.

The Patent EP 1 642 154 B1 shows an illumination system comprising at least two light sources emitting non-collinear and non-collimated light beams and an optical component for combining and integrating the two light beams. According to this patent, the light beams from the two separated light sources are again combined in such a way that the light beams are mixed within this light integrator. At the output of the light integrator an almost uniform illumination beam with the two mixed light beams is delivered.

In known illumination or projection systems the light beams of the plurality of light sources are converged or overlapped by means of optical elements in order to increase the light intensity energy of the combined light beam. In such systems it is often the aim to overlap or converge the light beams maximal.

An object of the invention is the alignment of light beams next to each other to enlarge the footprint or spot size and to change the dimension of the combined footprint compared to a separated single footprint of the light beams. Another object of the invention is the reduction of light losses through an optical element in a light path by adapting the dimensions of the footprint of the light beam passing the optical element and the dimensions of optical element to each other.

### SUMMARY

According to an embodiment, an illumination apparatus may have: a first light emitting diode (LED) configured to emit a first light beam, having a first rectangular footprint; a second light emitting diode (LED) configured to emit a second light beam, having a second rectangular footprint; wherein the first light source and the second light source are arranged facing each other; and an optical element, with two reflecting surfaces, the optical element being arranged between the first light emitting diode and the second light emitting diode, wherein the two reflecting surfaces are arranged relative to each other so that the first light beam is reflected at the first reflecting surface and the second light beam is reflected at the second reflecting surface, and so that the first reflected light beam and the second reflected light beam are aligned next to each other forming a combined light beam, with a combined more quadratic footprint, compared to the separate first and second rectangular footprints, wherein the combined more quadratic footprint comprises the first rectangular footprint and the second rectangular footprint aligned next to each other.

The finding of the invention is to add the beams of two light sources geometrically by placing the same next to each other. Embodiments of the invention relate to an illumination apparatus which is configured to align the light beams of two light sources next to each other by means of an optical element with two reflecting surfaces. The alignment of the two light beams next to each other is performed so that a combined light beam is formed. The combined light beam comprises a combined footprint comprising the footprints of the light beams of the light sources aligned next to each other. Furthermore, in other embodiments of the present invention an illumination system is described comprising an illumination apparatus wherein the footprints of the light beams of the light sources are rectangular and the combined footprint comprises a more quadratic shape. In some embodiments the footprints of the light beam have a aspect ratio of 16:9 and the combined footprint an aspect ratio 16:18. Light-emitting diodes (LEDs) emitting a light beam in 16:9 format can be combined forming a light beam in a more quadratic 16:18 format. Such (high-performance) LEDs my be used for, e.g. Spotlights, stage lights etc. These LEDs can be combined forming an uniform combined light beam, having dimensions which are fit better to the round spot or stage lights.

A round optical element which may affect the light intensity in the light path of the combined light beam may comprise a diameter which is adapted to a more quadratic shape, compared to the rectangular shape of the separated footprints. An advantage of the invention is the reduction of light losses due to an improved adaptation of the combined light beam and the optical element to each other. Furthermore, in some embodiments the alignment of two light beams is accomplished by the illumination apparatus and by the illumination system such that a subsequent projection optics can image the combined light beam as a single light beam, having the size of the two light beams.

### BRIEF DESCRIPTION OF THE DRAWINGS

With reference to the accompanying FIGS. 1-11, embodiments of an illumination apparatus and an illumination system will be described in more detail.

FIG. 1 shows a schematic drawing of an illumination apparatus according to an embodiment of the present invention.

FIG. 2 shows another embodiment of an illumination apparatus comprising LEDs as light sources according to another embodiment of the invention.

FIG. 3 shows a schematic top view of the rectangular footprint in a 16:9 format and the more quadratic shaped combined footprint in a 16:18 format.

FIG. 4 shows a schematic detailed view of an optical element with two mirrors of flat glass, wherein the edges of the mirrors of flat glass forming a tip are sloped to fit accurately together according to an embodiment of the invention.

FIG. 5 shows a schematic drawing of an illumination apparatus with misaligned light beams forming an overlapping combined light beam and causing a gap in the combined light beam.

FIG. 6 shows another schematic drawing of an illumination apparatus according to another embodiment of the invention.

FIG. 7 shows another schematic drawing of an illumination apparatus with a prism having at the tip an angle smaller than 90°.

FIG. 8 shows a schematic top view of a partly overlapping first and second footprint forming a combined footprint.

FIG. 9 shows a schematic top view of the footprints of the first and the second light beam wherein the footprints are separated by a gap so that the combined footprint comprises a dark shadow.

FIG. 10a shows a schematic drawing of an illumination system according to an embodiment of the invention.

FIG. 10b shows a schematic drawing of the combined footprint and a round optical element with a diameter adapted to the smaller side length of the combined footprint.

FIG. 11 shows a schematic drawing of the light loss due to the rectangular geometry of a footprint of a light source compared to the round geometry of a gobo.

FIG. 12 shows a schematic drawing of a reduced light loss due to the adapted quadratic shaped footprints of the combined footprint compared to the example in FIG. 11.

FIG. 13 shows another schematic d of an illumination apparatus with an optical element comprising concave reflecting surfaces according to an embodiment of the invention.

### DETAILED DESCRIPTION OF THE INVENTION

With reference to the following description of the embodiments of the present invention, it is to be noted that for simplification reasons, the same reference numerals will be used in the different figures for functionally identical or similarly acting or functionally equal or equivalent elements of steps throughout the description.

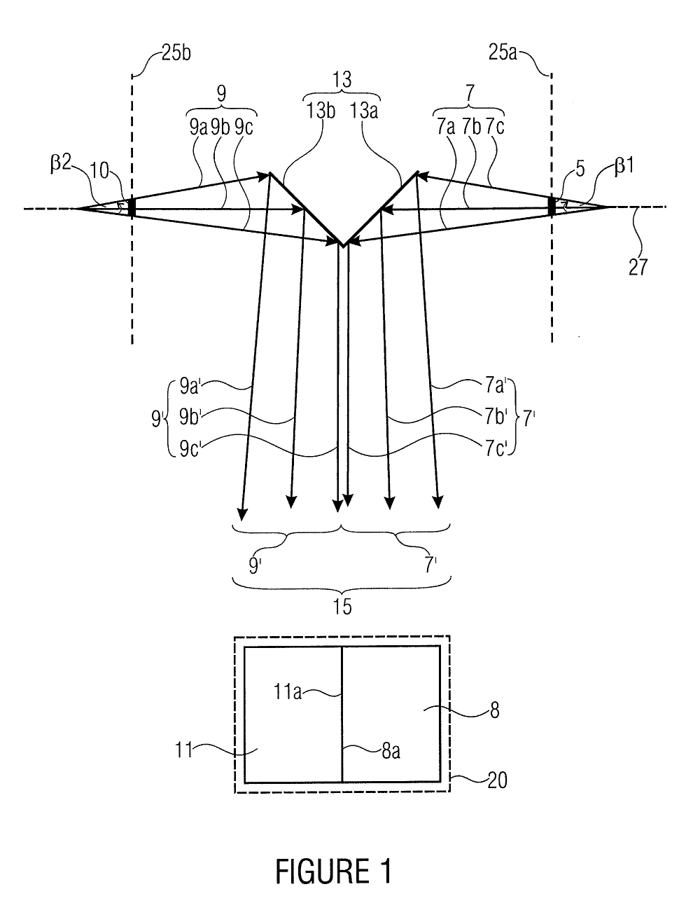

In FIG. 1, a schematic drawing of an illumination apparatus according to an embodiment of the present invention is depicted. The illumination apparatus comprises a first light source 5, wherein the first light source 5 is configured to emit a first light beam 7. The first light beam 7 comprises a first footprint 8, in this example, a rectangular footprint. The footprint or spot may comprise a different shape. The actual size of the footprint may depend on the imaging optics, the distance to a projection screen etc. The footprint may be imaged as sharply as possible. The illumination apparatus comprises furthermore a second light source 10 which is configured to emit a second light beam 9, having a second footprint 11. The first light source 5 and the second light source 10 are arranged so that they are facing each other.

In this embodiment the first light source 5 and the second light source 10 are arranged exactly 180° shifted so that the first and the second light beam would illuminate each other if the optical element 13 would be missing.

In other embodiments, both light sources may be arranged opposite to each other, but may be tilted compared to an optical axes defined by a exact shift of 180°. The light sources may be arranged, e.g., 90° to 270° shifted to each other. This means, in further embodiments of the invention the first and the second light source can be arranged facing each other so that the emitted light beams are just emitted in the direction of the opposite light source. In addition, the illumination apparatus comprises an optical element 13 with two reflecting surfaces 13a, 13b, wherein the optical element 13 is arranged between the first light source 5 and the second light source 10. The two reflecting surfaces 13a, 13b are arranged relative to each other so that the first light beam 7 is reflected at the first reflecting surface 13a and the second light beam 9 is reflected at the second reflecting surface 13b. The first reflected light beam 9′ and the second reflected light beam 7′ are aligned next to each other, forming a combined light beam 15 with a combined footprint 20 comprising the first footprint 8 and the second footprint 11, aligned next to each other.

The first light beam 7 may be illustrated by the marginal or edge rays 7a, 7c and the center ray 7b. This applies to the second light beam line with the two marginal or edge rays 9a, 9c and the center ray 9b as well. The first reflected light beam 7′ and the second reflected light beam 9′ are depicted correspondingly by the marginal rays 7c′, 7a′ and 9c′, 9a′ and the center rays 7b′ and 9b′.

The first light source 5 may comprise a principle plain 25a and the second light source may comprise a principle plain 25b. The center rays 9b and 7b may define in this embodiment an optical axis or auxiliary line 27.

According to this embodiment the illumination apparatus is configured to combine two light beams so that one combined light beam 15 is formed which comprises a cross-profile with an area within a range of ±10% of the sum of the areas of the first light beam 7 and the second light beam 9. Hence, the area of the combined footprint 20 can be within a range of ±10% the sum of the area of the first footprint 7 and the area of the second footprint 11. This means, the deviation of the sum of the separated footprints may be within ±10%. In other embodiments the area of the combined footprint may be within a range of ±20% the sum of the areas of the first and second footprints. According to some embodiments the area of the combined footprint 20 may be exactly, within a range of ±1%, the sum of the area of the first footprint 8 and the area of the second footprint 11.

The first light beam 7 may comprise an aperture β1. And the second light beam 9 may comprise a second aperture β2. The angle β1 and β2 may be equal. The illumination apparatus may be configured such that a combined light beam 15 of the first reflected beam 7′ and the second reflected beam 9′ has an aperture γ corresponding to the sum of the first aperture β1 and the second aperture β2. This means an aperture γ of the combined light beam 15 can be the sum of the first aperture β1 and the second aperture β2 (γ=β1+β2). According to an embodiment, this equation may be valid within a range of ±3°.

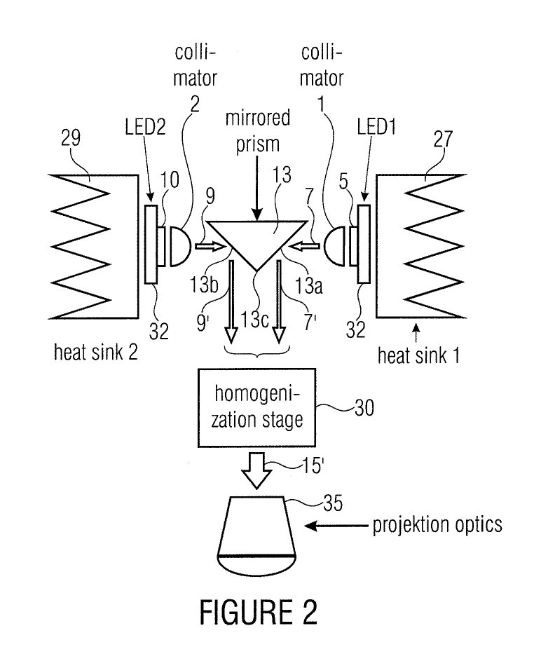

FIG. 2 shows a schematic drawing of an illumination apparatus according to another embodiment. In this embodiment the first light source 5 is a light emitting diode (LED1) which may be mounted on a substrate 32. The LED1 may be in thermal contact to a heat sink 1. The heat sink 1 may be arranged on the opposite side of the emitted first light beam 7. The heat sink 1 may be configured to absorb a heat or dissipation energy of the light-emitting diode during operation. A collimator 1 may be arranged in the light path of the first light beam 7 between the optical element 13 and the LED1. The collimator 1 may be configured to collect the emitted light from the LED1 and to form a nearly parallel first light beam with a reduced aperture compared to a light beam emitted from the LED1 without collimator 1. The second light source 10 may also be a light-emitting diode (LED2) on a substrate 29 wherein a separate second heat sink 2 is in thermal contact with LED2 in order to absorb the heat or dissipation energy during the operation of the second LED2. A collimator 2 is arranged in the light path of the second light beam 9 between the mirrored prism 13 and the LED2 so that the emitted light of the LED2 is collected. The second light beam 9 may comprise a smaller aperture compared to the configuration without a collimator.

In this embodiment the optical element 13 is a prism with two reflecting surfaces 13a and 13b, which are forming the legs of the prism. The reflecting surfaces 13a and 13b may be mirrored so that the first and the second light beam are reflected almost without any light loss. According to other embodiments, the reflecting surfaces may be formed by multiple dielectric layers causing a reflection or by an total reflecting optical element. The light beam may be reflected by an internal reflection in a prism. The reflected first light beam 7′ and the reflected second light beam 9′ may form the combined light beam 15.

The footprint of the LED1 and the LED2 may comprise a rectangular shape, e.g., with an aspect ratio of 16:9. This means the ratio of the side length of the longer side to the shorter side is 16:9. The combined footprint 20 of the combined light beam 15 may then comprise a more quadratic shape with an aspect ratio of 16:18 which corresponds to the two aligned footprints 8,11 with an aspect ratio of 16:18.

According to some embodiments an illumination apparatus may further comprise a homogenization stage 13, which is configured as a mixer stage. Thus, a “mixer stage” can be introduced after the beam combiner, i.e., the optical element 13. The mixer stage may be configured to level out, if the combined footprint comprises a partly overlapping first 8 and second footprint 11 or a first 8 and second footprint 11 separated by a gap. A homogenized combined light beam 15′ is formed by the homogenization or mixer stage.

A combined light beam 15 which comprises a combined footprint, partly overlapping or having a gap between the first and the second footprint, would be imaged by a subsequent projection optics or objective as the light beams of two separated LEDs. This means, a problem with this structure is that an objective Images, e.g., two LEDs as two light sources. This should be avoided. Hence, the homogenization stage 30 can be used to solve this problem.

After the mixer stage 30 a homogenized combined light beam 15′ may be imaged by the projection optics 35. An observer would consider the combined footprint of such a homogenized combined light beam, as a footprint of a single light source.

According to some embodiments, an illumination apparatus, as described, herein may be used in Spotlights or in rear projection television sets and may comprise a plurality of light sources or LEDs, wherein large combined footprints can be produced which comprises the footprints of the plurality of light sources.

In FIG. 2 the basic principle of the illumination apparatus is illustrated. Two light sources, for example, two high-performance LEDs 5, 10 are facing each other such that they would illuminate each other if no further optical element was mounted. In between is a prism arranged, whose faces, which are formed by the two legs, comprise surface mirrors or they are mirrored, e.g., with aluminum or argent. In some embodiments, the possibly needed homogenization stage 30 and an imaging objective, e.g. an objective 35 follows then. The LED1 and the LED2 are illustrated, as if they would emit light onto the center of the reflecting prism faces 13a and 13b. However, in reality the beams should hit the prism such that there is no gap at the front tip 13c of the optical element 13. If there is a gap at the front tip 13c, the combined light beam 15 may comprise an undesirable gap or overlap between the reflected first 7′ and second 9′ light beam.

Ideally, at this edge, the footprints of the first and the second LEDs should be imaged as sharply as possible in order to reduce the diffuse losses during the reflection. The footprints may be square footprints. Generally, the first and the second light beams, which are entering the system, i.e., which are reflected at the two reflecting surfaces 13a, 13b, should be as tightly focused as possible, since the efficiency of the reflections or dichroic coatings decreases with increasing incident or entry angle. The optical element or prism may comprise a dichroic coating acting as a color filter. Following the rules of the geometric optics, the angle of incident is equal to the angle of reflection. Focusing of the first 7 and the second 9 light beam may mainly be done in this embodiment by the two collimators (collimator 1,2), which are placed directly on the LEDs, in order to capture as much light as possible.

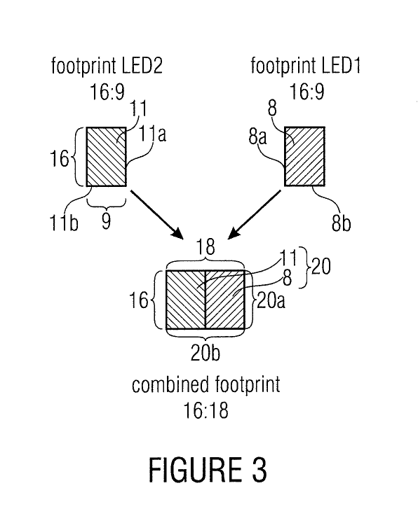

In FIG. 3 the result of the “beam addition” is schematically depicted. In this embodiment the footprint 8 of the LED1 and the footprint 11 of the LED2 comprising each an aspect ratio of 16:9. This means a longer side length 8a of the footprint 8 of the LED1 has compared to a shorter side length 8b an aspect ratio of 16:18. The same is true for the side lengths 11a and 11b of the footprint 11 of the LED2. The absolute size of the footprint 11 of LED2 and the footprint 8 of LED1 may depend on the projection optics and the distance to a projection screen. In contrast, the aspect ratio of a footprint may be constant, even if, for example, the absolute length of the side lengths is varied by changing the distance of the projection optics to a projection screen. If a light source, e.g., an LED chip 10 or 5 is focused a footprint in 16:9 format may be obtained, as it is now common in the field of video. The footprint may be sharply focused by a projection optics.

According to other embodiments, a footprint of a light beam may of course comprise a different aspect ratio, for example, 4:3. According to further embodiments the footprint shape may be different to rectangles or squares, after adding the light beams of the two LEDs 10, 5, to a combined light beam 15, having a combined footprint 20.

A combined footprint 20 may, as it is schematically shown in FIG. 3, comprise the first footprint 11 and the second footprint 8 aligned next to each other. The alignment may be done in an idealized case by fitting the longer side 11a of the second footprint 11 of the LED2 and the longer side 8a of the first footprint 8 of the LED1 together so that there is no gap or overlap between the footprints 11 and 8. After adding of the two footprints 11 and 8 with an aspect ratio 16:9, the side lengths of the combined footprint 20 may comprise an aspect ratio of 16:18. In this embodiment the combined footprint 20 may comprise a more quadratic shape with a first side length 20a and a second side length 20b. The ratio of the first side length 20a and the second side length 20b may be 16:18. As described above different aspect ratios or shapes may be achieved depending on the shape and aspect ratios of the single footprints 11 and 8.

The combined footprint 20 may comprise a more quadratic footprint shape compared to the single footprints 11 or 8 of LED1 and LED2. A more quadratic shape is given if the aspect ratio is closer to 1. If the aspect ratio is 1, then a quadratic shape is given, which means, e.g. the first side length 20a is equal to the second side length 20b. According to this the combined footprint with an aspect ratio 16:18 comprises a more quadratic shape as the rectangular footprint of LED1 and LED2 with an aspect ratio of 16:9. One aspect of the invention is to add the beams of the two LEDs geometrically by placing the same next to each other with the long side in a quasi-tangential way. In fact, this term is incorrect here, since both light beams form no curves, but it illustrates more clearly what is meant.

In the case of rectangular footprints, the longer sides, e.g., side 8a and 11a of the two rectangles can be aligned next to each other so that, if possible, there is no or only a less overlap or a small gap between the two different footprints 8,11. As a consequence a subsequent projection optics or objective may image the two LEDs with the two footprints as a single footprint of a single LED, but with a larger footprint size. This means, an observer of the combined footprint would perhaps not notice that the combined footprint is an addition of two aligned single footprints of two LEDs.

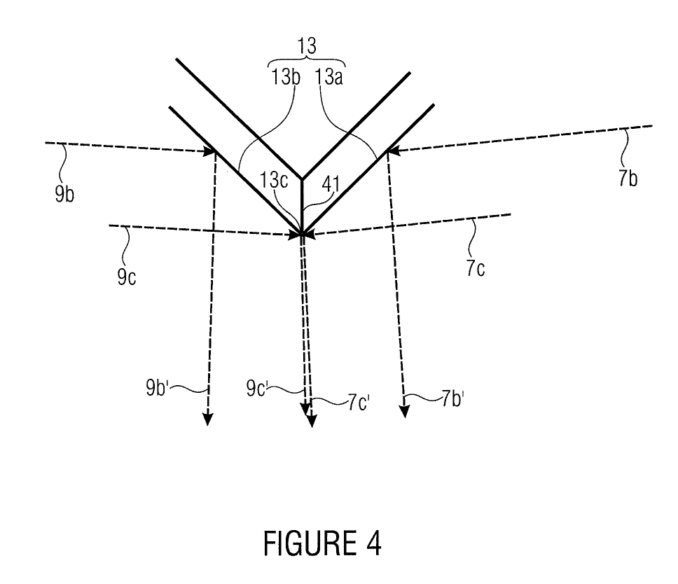

FIG. 4 shows an enlarged schematic side view of the front tip 13c of the optical element 13 according to an embodiment of the invention. In this embodiment the optical element 13 may comprise two mirrors of flat glass 13d and 13e comprising the two reflecting surfaces 13a and 13b of the illumination apparatus. The two mirrors of flat glass 13d and 13e are fitted together so that at the front tip 13c of the mirror triangle no gap or misalignment occurs. In order to accomplish this, the edges 41 of the two mirrors of flat glass 13d, 13e may be sloped so that they form a perfect front tip 13c, without a gap or misalignment. This may involve that depending on the incident angle of the first light beam 7 and the second light beam 9, the marginal rays 7c and 9c be reflected so that the reflected marginal rays 7c′ and 9c′ are aligned next to each other. The reflected marginal ray 7c′ of the first reflected light beam 7′ and the reflected marginal ray 9c′ of the second reflected light beam 9′ may be parallel aligned to each other. According to some embodiments, these two marginal rays 7c′ and 9c′ may be parallel arranged within a range of ±1° or within a range of ±3°. Depending on the quality of the alignment of the first 7′ and the second 9′ reflected beam, the combined footprint 20 comprises no or only a small overlap or gap and hence, the combined footprint 20 would comprise a shape with a size, area or aspect ratio which is given by an addition of the two single footprints 8,11 of the first 7 and second light beam 9.

If the edges 41 of the mirrors of the flat glass are not sloped so that there is no gap at the front tip 13c of the optical element 13, the mirrors of flat glass would not be suitable. Since it is of essential importance in this structure that the beams abut on each other without any “gap”. However, with mirrors, the front tip 13c of the mirror triangle would not be mirrored due to the material thickness and would thus significantly reduce performance if the mirrors of flat glass 13d, 13e are not sloped at the edges 41 forming front tip 13c.

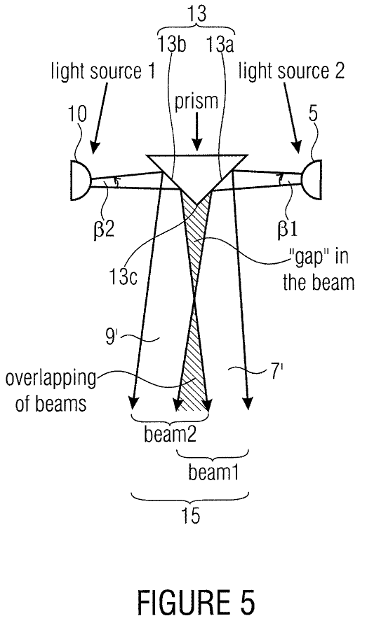

In FIG. 5 the schematic drawing of an Illumination apparatus with two light sources 5, 10, and an optical element 13 which may be, for example, a prism, is depicted. In this example, a misalignment or error of the combined light beam 15 may appear to such an extent that a gap or a certain overlap of the first 7′ and the second 9′ reflected beam occurs. Close to the front tip 13c of the prism, a gap in the combined beam 15 may occur. In this example the light source 1 and the light source 2 may be two LEDs being arranged offset by 180° and the optic element 13 is a standard 90° prism. This means, the angle between the two legs of the prism comprises is 90°. Since the first light beam 7 and the second light beam 9 comprise each an aperture of β1 and β2, which may be identical or different, a reflection of the light beam 9, 7 at the two reflecting surfaces 13a, 13b may result in the above described overlap of the reflected light beams 7′ and 9′. A gap between the beam 7′, 9′ occurs just behind the prism. If this gap is sharply projected, an image as described in context to FIG. 9 will result. Later, the reflected light beams 7′, 9′ overlap, in a way as described schematically in context to FIG. 8. As a consequence, objective or projection optics 35 (see FIG. 2) may image the two LEDs or the footprints of the two LEDs as two light sources with two separated footprints. This may be undesirable. An observer or person could recognize that the combined light beam 15 and its respective combined footprint 20 are made up of two or more separate light sources.

According to embodiments, collimators could be arranged in front of the light sources (see FIG. 2) in Order to diminish the aperture of the first and the second light beam and to form straight light beams. A straight first and second light beam 7, 9 may be reflected at a mirrored standard prism (90°), if the incident angle is 45°, with an angle of reflection of 45°. Hence the reflected light beams 7′, 9′ could be perfectly aligned next to each other forming a combined footprint, which comprises twice the size of the separated footprints. If the footprints, for example, are rectangles the combined footprint would comprise an aspect ratio, which depends on the aspect ratios of the single footprints.

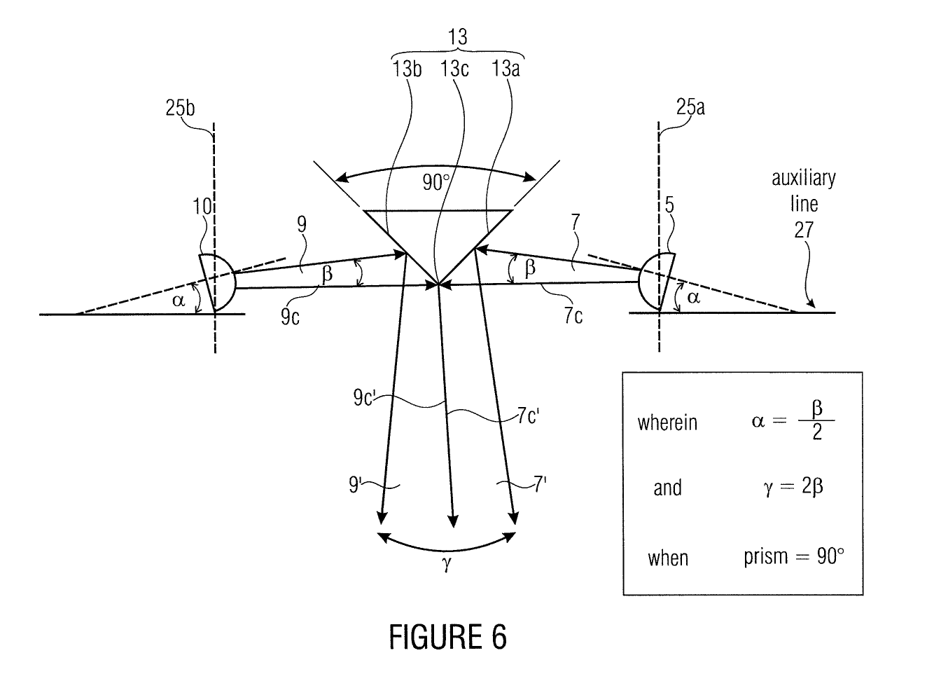

In FIG. 6, another schematic drawing of an illumination apparatus according to a further embodiment is shown. In this embodiment, the optical element 13 comprises again a standard 90° prism with two mirrored legs 13a and 13b, forming the two reflecting surfaces of the optical element 13. Each of the first light beam 7 and the second light beam 9 may comprise an aperture β. The first light source 5 and the second light source 10 may be tilted by an angle α to the principle plains 25a and 25b, which are defined by the light sources at a position with an offset by 180°. This means, the principle plans 25a and 25b are perpendicular to the optical axis or auxiliary line 27. The tilt angle α may be half of the aperture β of the light beams 7, 9 (α=β/2). If now the marginal ray 7c of the first light beam 7 and the marginal ray 9c of the second light beam 9 is reflected at the tip 13c of the prism 13, the corresponding reflected marginal light beams 9c′, 7c′ can be perfectly aligned next to each other, i.e. parallel with no gap or overlap. As a result, as it is shown in FIG. 6, the combined light beam 15 may comprise an aperture γ, wherein γ=2*β, if the prism is a standard prism with a 90° angle between the two legs 13a and 13b of the prism 13.

According to embodiments, an overlap or the occurrence of a gap between the two footprints forming the combined footprint can be avoided or reduced by tilting the light sources. One approach is, for example, to tilt the light sources, e.g., the LED light source by half of the aperture angle of the light beams 7,9. A LED light source, which is tilted, may comprise the substrate 32, 29, the respective collimators 1,2 and the heat sinks 1, 2, as described in context of FIG. 2. Thereby, the marginal rays 7c′ and 9c′of the two beams 7,9 abut on each other. The two beams span a common useful light beam 15, which has twice the aperture angle of the original beams. Thereby, the two light sources act like one large light source for the objective or projection optics 35 (see FIG. 2). As it is shown in FIG. 2, the first and the second light source may comprise each a heat sink 1,2, which is mounted, e.g., at the flipside of a substrate 32,29 of the LED1,2.

For the purpose of a simple configuration of the heat sink, it would be desirable that the cooling faces of the LEDs are parallel but rotated by 180°. This configuration would, according to an embodiment of the invention, be possible, with a specific prism or arrangement of the reflecting surfaces 13a, 13b, whose mirrored faces span an angle of less than 90°.

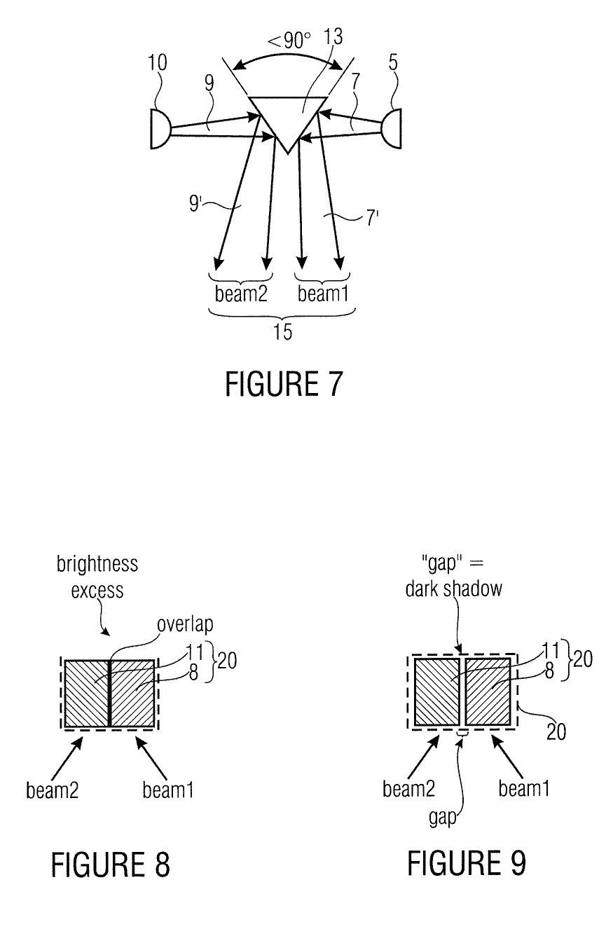

This embodiment is schematically shown in FIG. 7. An optical element 13, for example, the reflecting surfaces 13a,13b of a prism or two mirrors of flat glass are relatively arranged to each other so that the angle at the tip 13c of the prism or between the mirrors of flat glass is less than 90°. It should be noted that the tip 13c may be an edge of the optical element or prism 13 in three-dimensions. In other embodiments of the invention, the two reflecting surfaces 13a, 13b may be arranged relatively to each other so that they comprise an angle in a range between 100° and 30°, for example, between 95° and 50°. In such a case, the first light beam 7 and the second light beam 9 may be again reflected in such a manner that the first reflected light beam 7′ and the second reflected light beam 9′ are aligned next to each other. The reflected light beams form the combined light beam 15 with the combined footprint 20, which is comprising the first footprint and the second footprint aligned next to each other. The first 7 and the second 9 light beam can be directed close to the front tip or edge 13c of the optical element or prism 13 so that the reflected light beams 7′ and 9′ are aligned parallel next to each other. In other words if the single beams 7, 9 are directed close enough to the front edge 13c, there is no gap or overlapping of the first 7′ and the second 9′ reflected light beam forming the combined light beam 15.

However, sometimes it may be difficult to receive an ideal image or ideal combined footprint. Rather, there can be variations in the combined footprint that look like FIGS. 8 and 9.

In FIG. 9, the schematic combined footprint 20 of two single footprints 8 and 11 of the first and the second light beam is depicted. In this example, the two single footprints 8, 9 may partly overlap, and hence, the combined footprint 20 may comprise brightness excess at the overlapping part of the beam 1 and beam 2. A light intensity may be given by a superposition of the light beams in this area.

As described above, another “misalignment” may cause, as it is schematically shown in FIG. 9, a “gap”, which is comparable to a dark shadow in the combined footprint 20. Therefore a combined footprint 20 may comprise a larger or smaller size or area, or a different aspect ratio than it would be given by an addition of the areas of the single footprints or spots 8, 11 of the first 7 and second light beam 9. According to embodiments, the area of the combined footprint may be within a range of ±10% the sum of the area of the first footprint and the area of the second footprint. This means, the deviation regarding the area of the combined footprint compared to the areas of the single footprints may be smaller or equal 10%. In other words, the area of the combined footprint may be 10% or less larger or it may be 10% or less smaller than the sum of the areas of the first and the second footprint. The same may be valid with respect to a maximum overlap of the combined light beam 15 compared to the area of the reflected single light beams 7′, 9′.

If the footprint of the first and the second light beam is rectangular, the same may be true with respect to the aspect ratios of the single footprint and the combined footprint 20. If, for example, the first and the second footprint each comprising an aspect ratio of X:Y, then the combined footprint may comprise an aspect ratio of (X:2Y)±10%. The footprint of the single light beams may be, exemplarily, 16:9, as described above, and hence the combined footprint may have a ((16:18)±10%) format. This means that the aspect ratio of the combined footprint 20 may comprise a deviation of ±10% compared to an ideal aspect ratio of the exactly assembled first and second footprint.

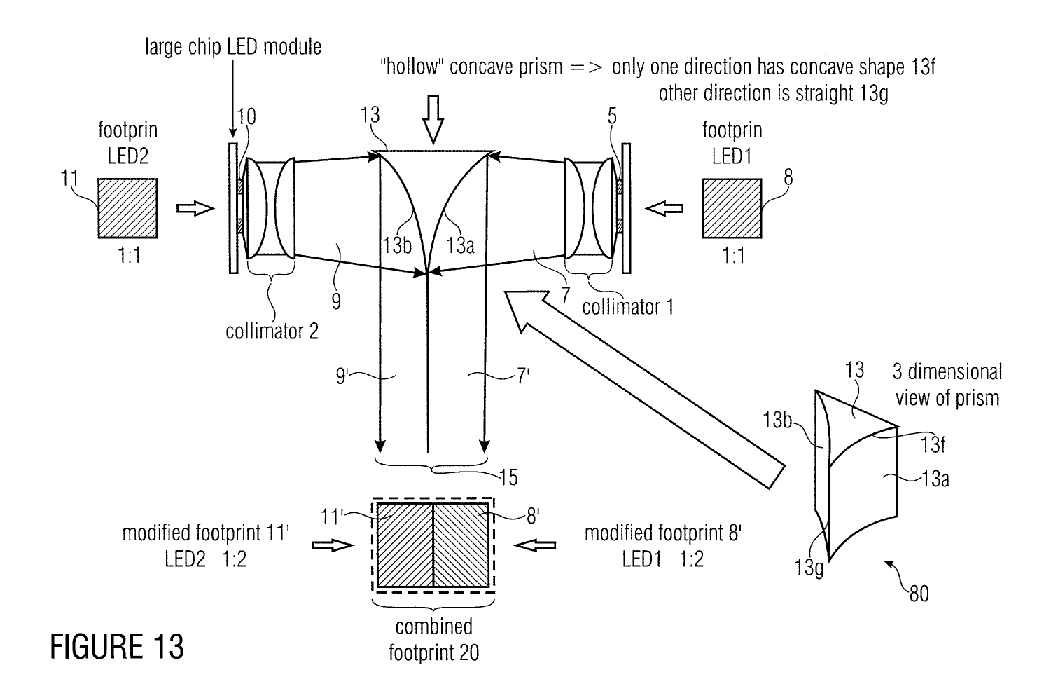

FIG. 13 shows another embodiment of an illumination apparatus. The first light source 5 and the second light source 10 may be again LEDs (LED1, LED2). Each LED may be a LED module, e.g. a large chip LED module. The footprint of the LED1 and the footprint of the LED2 may be quadratic, i.e. comprise an aspect ratio of 1:1. The first light beam 7, which is emitted from the LED2 may pass a collimator 1, which is configured to collect the emitted light from the LED2 and to form a more parallel first light beam 7. The second light beam 9, which is emitted from the LED2 is also passing such a collimator 2.

In this embodiment the two reflecting surfaces 13a and 13b may comprise a curvature. The first 13a and the second 13b reflecting surface may, for example, be formed concave, wherein the curvature may be dimensioned so that the first 7′ and second 9′ reflected beam comprise half of the aperture of the incident light beams 7, 9. The first and the second light beams 7 and 9 may be reflected, at the concave reflecting surfaces so that the first and the second reflected beams 7′, 9′ do not comprise a focal point. Because of the reflection at the concave or curved reflecting surfaces 13a, 13b the footprint of the reflected light beams 7′ and 9′ may have changed, as schematically depicted in FIG. 13, so that modified footprints 8, 11′ are achieved. The modified footprint 8′ of LED1 may now comprise an aspect ratio 1:2 and the modified footprint 11′ of the LED 2 may also comprise an aspect ratio of 1:2.

The first reflected light beam 7′ and the second reflected light beam 9′ are aligned again next to each other so that a combined light beam 15 is formed. The combined light beam 15 may now comprise a combined footprint with the modified footprint 8′ of the LED1 and the modified footprint 11′ of the LED2 aligned next to each other. It should be noted that the modified footprint 8′ of LED1 may comprise the footprint 8 of LED1 and the modified footprint 11′ of LED2 may comprise the footprint 11 of LED2.

According to this embodiment the combined footprint 20 and the combined light beam 15 comprise a quadratic shape with an aspect ratio of 1:1. In addition the combined footprint and the combined light beam may comprise a brightness or light intensity which is higher than the brightness of the light intensity of the single LED1 or LED2. The combined light beam 15 and the combined footprint 20 can comprise a brightness or light intensity which is two times higher than the light intensity or brightness of a single LED1 or LED2. The optical element 13 may be a prism, for example, a “hollow prism” with concave reflecting surfaces 13a, 13b wherein one direction of the reflecting surfaces has a concave shape 13f and the other direction is straight 13g. A three dimensional view 80 of such a prism is shown in FIG. 13 as well.

According to other embodiments the reflecting surfaces may have a different curvature, for example, a convex curvature or parts of the reflecting surface 13a, 13b may be curved and other parts of the reflecting surfaces may be straight. In general the reflecting surface can comprise a certain bending, so that the aspect ratio of the incident light beams 7,9 can be changed and the reflected light beams 7′, 9′ can be parallel aligned within a range of ±3° to form a combined beam 15 with an combined footprint comprising the modified footprints 8′, 11′. Furthermore it should be noted that in other embodiments the optical element 13 may be made up of mirrors of flat glass or other reflecting elements with two reflecting surfaces 13a, 13b comprising a curvature as described above.

The illumination apparatus can comprise an optical element 13, in which at least one reflecting surface 13a, 13b is convex or concave, so that the reflected beam 7′, 9′ which is reflected by the convex or concave reflecting surface 13a, 13b has an aspect ratio different from an aspect ratio of the corresponding light beam 7, 9 impinging on the concave or convex reflecting surfaces 13a, 13b. This means that the aspect ratio of an impinging or incident light beam may be changed by the curved reflecting surface. These reflecting surface may be, for example, convex, concave or in general curved or partly curved.

According to another embodiment of an illumination apparatus an aspect ratio of the light beams 7, 9 impinging on the reflecting surfaces 13a, 13b is A:B. Thereby A is equal to B or different from B by less than 10% of B. This means that the aspect ratio may be, for example, 1:1 as described above within a range of ±10%. In this embodiment at least one reflecting surface 13a, 13b is concave so that the aspect ratio of the corresponding reflected light beam 7′, 9′ is A:(B/X), wherein X is between 1.5 and 2.5. An addition of two such reflected light beams may then result in a combined light beam 15 and a combined footprint 20 which comprises again a quadratic shape with an aspect ratio of 1:1 within a range of ±10%.

An illumination apparatus may comprise such a special prism, as described above, wherein the basic idea is the combination of two beams with an quadratic aspect ratio of 1:1. Currently LED manufacturers use a series of efficient LEDs for general lighting purposes, wherein the light beams of such efficient LEDs comprise often a quadratic aspect ratio. A simple addition of the light beams of two such LEDs would result in an aspect ratio of 1:2. In order to receive after the addition of the light beams of such LEDs a combined light beam and a combined footprint with a more quadratic shape (aspect ratio 1:1) an illumination apparatus as described in the context of FIG. 13 may be used.

The optical element 13 of such an illumination apparatus may be a prism which is formed, so that the prism is curved in one plane concave 13f and the other plane 13g may be flat. The prism behaves in one spatial plane like a “normal” mirror, whereas in another spatial plane a certain focusing of the light beams is achieved. As a consequence the aspect ratio, for example, of a light beam with an quadratic aspect ratio of 1:1, is modified so that the reflected light beam comprises a modified rectangular aspect ratio 1:2 and hence the corresponding modified footprint as well.

The curvature of the prism may be dimensioned so that the reflected light beam 7′, 9′ comprises an aperture within a range of ±5°, which corresponds to half of the aperture of the incident or impinging light beam 7,9. The curvature of the reflecting surfaces of the prism may be configured so that no focal point is formed. The first and the second light beam 7, 9 may illuminate the reflecting surface 13a, 13b flat or two dimensionally.

If the prism is configured to change the aspect ratio 1:1 of the beams 7,9 in a 1:2 aspect ratio, then the two reflected light beams 7′, 9′ can again be aligned in parallel next to each other and a quadratic combined light beam 15 (aspect ratio 1:1) can be achieved.

According to other embodiments of the invention this system or illumination apparatus can be cascaded if two such described illumination apparatuses illuminate again a larger prism so that a quadratic beam with 4 separate controllable segments or quadrants can be achieved. Such a system may comprise four LEDs, which may emit light in a different spectral range, so that each of the four separate controllable quadrants can be illuminated by a different color or by a combination of the emitted light. According to an embodiment the first LED may comprise a red emission spectra, the second LED may comprise a blue emission spectra, a third LED may comprise a green emission spectra and a fourth LED may comprise a white or amber emission spectra. The separate controllable light beams forming the combined light beam 15 with the four quadrants, which are individually controllable may be controlled so that for an observer certain special optical effects can be achieved.

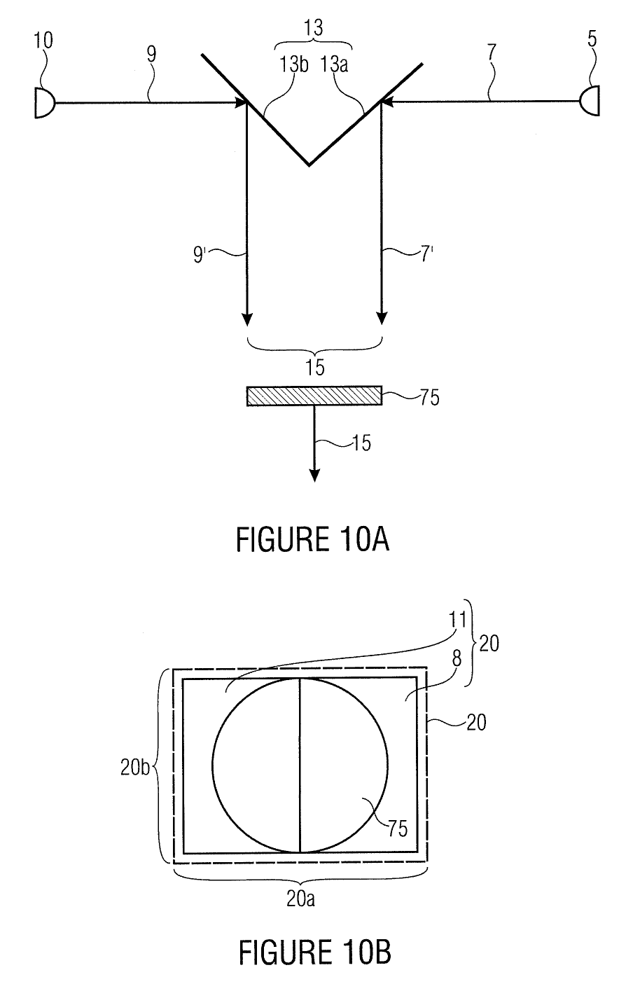

Since it may sometimes difficult to receive an ideal image of the combined footprint, as it is shown in FIG. 3, and hence there may be variations that look like as described in context to FIGS. 8 and 9, a homogenization stage 30 or a “mixer stage” can be introduced in the illumination apparatus. In FIG. 2, the homogenization stage 30 may be arranged after the beam combiner 13. This homogenization stage or mixer stage may be configured to level out the effects of overlapping and dark shadows of gaps in the combined footprint 20. Such an mixer stage 30 can either be an arrangement of two micro lens arrays or a “light tunnel” which may be a hollow light rod which is mirrored on the inside, as it is used, for example, in video beamers. The light tunnel may comprise a diameter, which is corresponding to the diameter of the combined footprint. The light tunnel may have a square diameter for hollow light tunnels and may be hexagonal for massive “light pipes”. The hexagonal shape results in a better mixture of the incident combined light beam 15 and utilizes a round gobo 75 (FIG. 10b) better. The homogenized combined light beam 15′ may then be imaged by a projection optics 35, as it is shown in FIG. 2, on a projection screen etc.

In FIGS. 10a, 10b, an illumination system 200 is schematically depicted. The illumination system 200 comprises a first light source 5, configured to emit a first light beam 7, having a first rectangular footprint 8 and a second light source 10, which is configured to emit a second light beam 9, having a second rectangular footprint 11. The first light source 5 and the second light source 10 are arranged facing each other. The illumination system 200 further comprises an optical element 13 with two reflecting surfaces 13a and 13b being arranged between the first light source 5 and the second light source 10. The two reflecting surfaces are arranged relatively to each other so that the first light beam is reflected at the first reflecting surface 13a and the second light beam 9 is reflected at the second reflecting surface 13b. The first and the second reflected light beam 7′,9′ are aligned next to each other forming a combined light beam 15 with a combined footprint 20, wherein the combined footprint 20 comprises a more quadratic shape compared to the separate first and second rectangular footprints. The illumination system 200 further comprises a round optical element 75 in the light path of the combined light beam 15, wherein the round optical element 75 or parts of the round optical element 75a are transparent, semi-transparent or able to change the color of the passing combined light beam 15. The diameter D of the round optical element is according to some embodiments adapted to the quadratic shape of the combined footprint (FIG. 10b). This means, according to an embodiment, the diameter D of the round optical element 75 is equal or identical, at least within a range of ±10%, to the shorter side length 20b of the combined footprint 20. According to another embodiment, the combined footprint 20 does not exactly comprise a quadratic shape, but it may comprise a more quadratic shape compared to the single footprints 8, 11. In this case, the diameter D of the round optical element 75 may be adapted to the smaller or shorter side length 20b of the more quadratic shaped combined footprint 20.

The round optical element 75 may be a gobo or a mask. It may be made of metal and act as a pattern or it may be made of glass with a transparent, semi-transparent or color filter. The color filter may be used to change the color of the combined light beam passing the round optical element 75. If the illumination system 200 comprises a first LED 5 and a second LED 10, having a first rectangular footprint and a second rectangular footprint with an aspect ratio 16:9, the combined footprint may comprise an aspect ration 16:18. The illumination system adds the beams of the two LEDs geometrically by placing the same next to each other with the long side in a quasi-tangential way and a combined light beam with an aspect ratio of 16:18 would result. Apart from twice the energy, this would have another advantage. The gobos to be trans-illuminated are usually round. A gobo 75 is a template or pattern cut into a circular plate used to create patterns of projected light. Gobos may control a light by blocking, coloring or diffusing some portion of the beam before it reaches a projection optics. Because the light is shaped before it is focused, hard edges Images can be projected over short distances. The illumination system may therefore also comprise a projection optics, which may have movable lenses to allow sharp or soft focusing. A gobo may be made, e.g., from either sheet metal or glass, depending upon the complexity of the design. Glass gobos can include colored areas, made of multiple layers of dichroic glass, one for each color glued on an aluminium or chromed-coated black and white gobo. New technologies make it possible to turn a color photo into a glass gobo. The gobo may also be a plastic gobo with special cooling elements to prevent melting them. The gobo may be placed in the focal plain of the combined light beam. Gobos can provide different light effects. They are commonly used in stage lighting, television and film production to create texture, mood, or special effects.

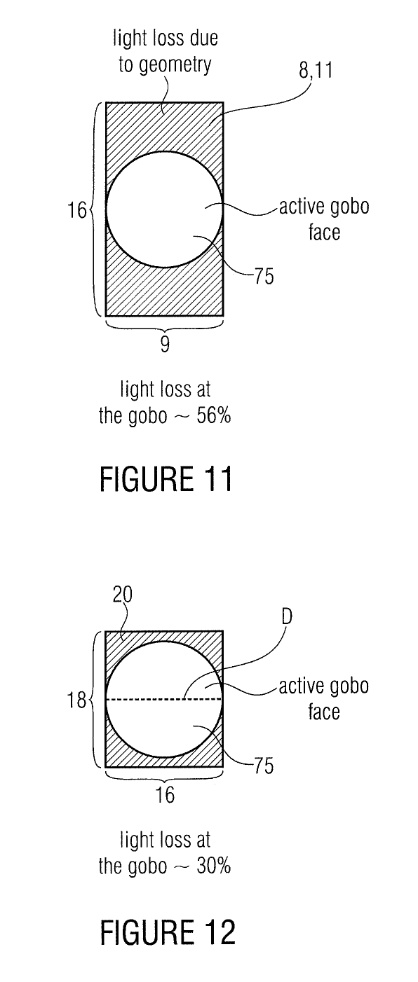

If now the round gobos are illuminated with a 16:9 beam, the narrow side of the beam square has to cover the complete diameter of the gobo. This is schematically shown in FIG. 11. A footprint, for example, the first footprint 8, may comprise an aspect ratio 16:9. Then, an optical element, for example, a gobo 75 with a round active area results in a light loss due to the geometry. In the case, shown in FIG. 11, the light loss at the gobo is because of the different geometry of the rectangular footprint about 56%. This means 56% of a rectangular light beam may be blocked by the round gobo. The active gobo face is round and should be adapted to the rectangle light beam with an aspect ratio of 16:9. As a consequence a huge light loss of 30% to 70% may occur. Here, the result is that approximately 56% of the light energy does not longer fall through the gobo.

According to an embodiment of the illumination system 200, the combined light beam 15 may comprise a combined footprint in a 16:18 format. As a consequence, as it is schematically shown in FIG. 12, the light loss at the gobo is reduced to approximately 30%. This means, because of the adapted diameter D of the active gobo face 75 to the more quadratic shaped combined footprint 20 a reduction of the light loss or energy loss can be achieved according to an embodiment. Depending on the adaptation of the optical element to the combined light beam, a light loss of combined light beam at optical element can be reduced up to 50%.

In another embodiment the illumination system may further comprise a homogenization stage 30, which is arranged in the light path of the combined light beam. The homogenization stage 30 is configured to mix the combined light beam 15 to form a mixed combined light beam 15′. The illumination system further comprising a projection optics 35, which is arranged in the light path of the mixed combined light beam 15′ and which is configured to image the mixed combined light beam 15′. The round optical element 75 is arranged in the light path of the mixed combined light beam 15′ between the homogenization stage 30 and the projection optics 35.

The homogenization stage 30 may be a light tunnel, as it is used, in video beamers. The light tunnel may have a square diameter for hollow light tunnels and may be hexagonal for massive light pipes or light tunnel. The hexagonal shape results in a better mixture and utilizes the round gobo better. However, attenuation in the bulk material might be a bit higher.

According to some embodiments, the invention relates to an LED spot or footprint. Several LED light sources exist, which would possibly be suitable for lighting such a system or illumination apparatus or illumination system. However, the problem might be that one and not several light sources may be needed for a spot variation that means an imaging system. For building different devices with different power glasses, appropriate LED light sources may be needed according to some embodiments. The financial effort for the development would be enormous.

High performance LEDs, as they are used in rear projection television sets, are the basis of the system according to some embodiments. Such high performance LEDs may have a high brightness and may emit, for example light, in the visible spectral range (750 nm-450 nm). The power consumption of such high performance LED chip may be, for example, up to 100 Watt, i.e., for example, 80 Watt. Hence, a sufficient cooling is to be ensured. Therefore, it is a further advantage of the invention described above, that the light sources, for example, the high performance LEDs can be arranged separately at opposite sides so that the separate light sources are facing each other. As a consequence, each light source, for example, each high performance LED, can comprise its own heating sink, as described in embodiments of the invention. Therefore an effective cooling of the high performance LEDs during operation may be ensured. The high performance LEDs may emit the light energy as Lambert emitter, this means, it may comprise the same brightness independent of a viewing angle.

According to embodiments, the light sources may be LED chips which are focused and which then comprise a footprint or a spot shape in a 16:9 format. This is a format, which is now common in the field of video. In order to achieve this, the LEDs may comprise an active emitting area that also comprises a 16:9 aspect ratio.

While this invention has been described in terms of several embodiments, there are alterations, permutations and equivalents which fall in the scope of this invention. It should also be noted that there are many alternative ways of implementing the illumination apparatus and the illumination system as described herein. It is therefore intended that the following depending claims are interpreted as including all such alterations, permutations and equivalents as fall within the true spirit and scope of the present invention.

1. An illumination apparatus, comprising:
a first light emitting diode configured to emit a first light beam, comprising a first rectangular footprint;
a second light emitting diode configured to emit a second light beam, comprising a second rectangular footprint;
wherein the first light source and the second light source are arranged facing each other; and
an optical element, with two reflecting surfaces, the optical element being arranged between the first light emitting diode and the second light emitting diode, wherein the two reflecting surfaces are arranged relative to each other so that the first light beam is reflected at the first reflecting surface and the second light beam is reflected at the second reflecting surface, and so that the first reflected light beam and the second reflected light beam are aligned next to each other forming a combined light beam, with a combined more quadratic footprint, compared to the separate first and second rectangular footprints, wherein the combined more quadratic footprint comprises the first rectangular footprint and the second rectangular footprint aligned next to each other.

2. The illumination apparatus according to claim 1, wherein the rectangular shape of the first rectangular footprint and the rectangular shape of the second rectangular footprint comprise an aspect ratio of 16:9 and the rectangular shape of the combined more quadratic footprint comprises an aspect ratio of 16:18.

3. The illumination apparatus according to claim 1, wherein the rectangular shape of the first rectangular footprint and the rectangular shape of the second rectangular footprint comprise an aspect ratio of X:Y and the combined more quadratic footprint comprises an aspect ratio of ((X:2*Y)±10%).

4. The illumination apparatus according to claim 1, wherein the first reflecting surface and the second reflecting surface are arranged relative to each other, so that an angle, ranging from 100° to 30° is formed, at a common tip.

5. The illumination apparatus according to claim 1, wherein the optical element is a prism and the two reflecting surfaces, forming the legs of the prism, are mirrored.

6. The illumination apparatus according to claim 4, wherein the first reflecting surface and the second reflecting surface are mirrors of flat glass, and wherein the edges of the mirrors of flat glass are sloped forming a common tip, accurately fitting together.

7. The illumination apparatus according to claim 1, wherein the area of the combined more quadratic footprint is within a range of ±10% the sum of the area of the first rectangular footprint and the area of the second rectangular footprint.

8. The illumination apparatus according to claim 1, further comprising a first collimator in the light path of the first light beam and a second collimator in the light path of the second light beam.

9. The illumination apparatus according to claim 1, wherein the first light beam comprises a first aperture β1 and the second light beam comprises a second aperture β2, and wherein the aperture γ of the combined light beam is within a range of ±3° the sum of the first aperture and the second aperture (γ=(β1±β2)±3°).

10. The illumination apparatus according to claim 1, wherein the first light source and the second light source are arranged 180° shifted, facing each other, so that an optical axis is defined by the center ray of the first light beam and the second light beam, and wherein a principle plain of the first light emitting diode is tilted with respect to the optical axis by half of a first aperture β1 of the first light beam and a principle plain of the second light emitting diode is tilted with respect to the optical axis by half of a second aperture β2 of the second light beam, so that a marginal beam of the first reflected beam and a marginal beam of the second reflected beam are parallel within an angle of ±2°.

11. The illumination apparatus according to claim 1, further comprising a homogenization stage configured to mix the combined light beam.

12. The illumination apparatus according to claim 1, further comprising a projection optics configured to image the combined light beam.

13. The illumination apparatus according to claim 1, wherein the first LED comprises a first heat sink and the second LED comprises a second heat sink.

14. The illumination apparatus according to claim 1, in which at least one reflecting surface is convex or concave, so that a reflected beam reflected by the convex or concave reflecting surface comprises an aspect ratio different from an aspect ratio of the corresponding light beam impinging on the convex or concave reflecting surface.

15. The illumination apparatus according to claim 14, in which an aspect ratio of the light beam impinging on the reflecting surface is A:B, wherein A is equal to B or different from B by less than 10% of B, wherein the at least one reflecting surface is concave so that the aspect ratio of the corresponding reflected light beam is A:(B/X), wherein X is between 1.5 and 2.5.

16. The illumination apparatus according to claim 1, further comprising
a round optical element in the light path of the combined light beam, wherein the round optical element is transparent or semitransparent for the combined light beam, or able to change the color of the combined light beam, and wherein the diameter D of the round optical element is adapted to the quadratic shape of the combined more quadratic footprint formed by the rectangular first and second footprint.

17. The illumination apparatus according to claim 16, further comprising a homogenization stage arranged in the light path of the combined light beam, wherein the homogenization stage is configured to mix the combined light beam to form a mixed combined light beam, and a projection optics which is arranged in the light path of the mixed combined light beam and which is configured to image the mixed combined light beam, and wherein the round optical element is arranged in the light path of the mixed combined light beam between the homogenization stage and the projection optics.

18. The illumination apparatus according to claim 16, wherein the round optical element is a gobo.
